(19) United States
(12) Patent Application Publication
(10) Pub. No.: US 2025/0247045 A1
(43) Pub. Date: Jul. 31, 2025

(54) VARIABLE ANGLE TORQUE TUBE CONNECTOR

(71) Applicant: ARRAY TECH, INC., Albuquerque, NM (US)

(72) Inventors: Diego Azofra Rojo, Logroño (ES); Nathan Schuknecht, Golden, CO (US)

(21) Appl. No.: 19/014,703

(22) Filed: Jan. 9, 2025

Related U.S. Application Data
(60) Provisional application No. 63/624,901, filed on Jan. 25, 2024.

(51) Int. Cl. H02S 20/32; F24S 30/00; F24S 30/455

(52) U.S. Cl. CPC H02S 20/32; F24S 30/455; F24S 2030/136

(57) ABSTRACT

Variable angle torque tube connectors are described that include a means for connecting different torque tube sections at different angular orientations. The means for connecting may also translate rotation from one torque tube section to another. In some embodiments, the variable angle torque tube connector may also include a means for applying a rotational torque to a component of the means for connecting different torque tube sections in order to rotate the torque tube sections so that attached photovoltaic modules track a location of the Sun throughout the day.

### CROSS-REFERENCE TO RELATED APPLICATION

This application claims priority under 35 U.S.C. § 119 to U.S. Provisional Application No. 63/624,901, filed Jan. 25, 2024, the entire disclosure of which is incorporated herein by reference.

### FIELD OF THE INVENTION

The present disclosure generally relates to variable angle torque tube connectors that may be used in photovoltaic module systems that are installed in locations having inconsistent topographies.

### BACKGROUND

Systems of photovoltaic (PV) modules capture and convert sunlight into electricity, which may be provided to various off-site applications, such as providing electricity for residential homes and commercial buildings. Large-scale systems of PV modules, or solar farms, may be equipped with solar tracker capabilities that allow the PV modules to follow movement of the Sun to increase the amount of sunlight incident on the surfaces of the PV modules and the amount of energy generated by the PV modules. A large number of individual PV modules may be secured to a single torque tube, which is rotated by a drive motor so that the attached PV modules track the movement of the Sun in the sky throughout the day. In large-scale solar tracking systems, a plurality of torque tubes may be arranged adjacent to one another in a series of parallel rows. These rows of torque tubes may be anchored to the ground and supported by a series of piles or support structures.

Large-scale solar tracking systems often span several acres. Because these sites span such large areas, inconsistent topographies and elevation changes are often inevitable. Inconsistent topographies and elevation changes in the terrain may affect the placement and positioning of PV modules. This is because solar tracking systems may fail to operate properly or efficiently if torque tubes are not positioned in straight lines, but are required to bend or curve. Thus, variations in terrain elevation that prevent torque tubes from being positioned in straight lines may prevent a torque tube from rotating properly, reducing the power output of the plant and/or causing the solar tracker to fail.

To create level terrain for large-scale solar tracking systems, elevation changes may be eliminated by leveling the land before installation. However, flattening hills and filling in valleys is not only expensive and time consuming, it can create additional problems. For example, if a layer of topsoil is removed to eliminate a hill, this area may be more susceptible to erosion over time.

The subject matter claimed in the present disclosure is not limited to embodiments that solve any disadvantages or that operate only in environments such as those described above. Rather, this background is only provided to illustrate one example technology area where some embodiments described in the present disclosure may be practiced.

### SUMMARY

Example embodiments of the present disclosure address problems experienced in conventional PV module systems, including problems associated with installation of PV module tracking systems in environments that include significant slope changes. Embodiments disclosed herein address this problem by providing a variable angle torque tube connector that includes a means for connecting that not only connects torque tube sections at different angular orientations, but also translates rotation from one torque tube section to another. In some embodiments, the variable angle torque tube connector may also include a means for applying a rotational torque to a component of the means for connecting in order to rotate the torque tubes so that attached PV modules track the location of the Sun throughout the day.

In one embodiment, connector for coupling torque tube sections at variable angles in a solar tracking system may include a frame that includes a first sleeve that is rotatably connected to a first arm of the frame and is configured to be fixed to a first torque tube section, and a second sleeve that is rotatably connected to a second arm of the frame and is configured to be fixed to a second torque tube section. The connector may also include a first gear that includes a first toothed wheel, a first pinion, and a first axle. The first gear may be a spur gear, a miter gear, or another type of gear. The first toothed wheel may be fixed to the first sleeve to translate rotation from the first torque tube section to the first axle. The connector may also include a second gear that includes a second toothed wheel, a second pinion, and a second axle. The second gear may be a spur gear, a miter gear, or another type of gear. The second toothed wheel may be fixed to the second sleeve to translate rotation from the second torque tube section to the second axle. Finally, the connector may include a joint that connects and translates rotation from the first axle to the second axle.

In another embodiment, a connector for coupling torque tube sections at variable angles in a solar tracking system may include a first torque tube coupler that is configured to be coupled to a first torque tube section and is fixed to an inner ring that includes exterior grooves. The connector may also include a second torque tube coupler that is configured to be coupled to a second torque tube section and is fixed to an outer ring that surrounds the inner ring. The outer ring may include interior grooves. Finally, the connector may include a plurality of rollers positioned between the exterior grooves of the inner ring and the interior grooves of the outer ring.

In another embodiment, a connector for coupling torque tube sections at variable angles in a solar tracking system may include a first torque tube coupler that is configured to be coupled to a first torque tube section and is fixed to a first inner ring that includes exterior grooves. The connector may also include a second torque tube coupler that is configured to be coupled to a second torque tube section and is fixed to a second inner ring that includes exterior grooves. The connector may also include an outer ring that surrounds the first inner ring and the second inner ring and includes interior grooves. Finally, the connector may include a plurality of rollers that are positioned between the exterior grooves of the first and second inner rings and the interior grooves of the outer ring.

The object and advantages of the embodiments will be realized and achieved at least by the elements, features, and combinations particularly pointed out in the claims. It is to be understood that both the foregoing general description and the following detailed description are explanatory and are not restrictive of the invention, as claimed.

### BRIEF DESCRIPTION OF THE DRAWINGS

Example embodiments will be described and explained with additional specificity and detail through the accompanying drawings in which:

FIG. 1 illustrates a solar site that includes elevation changes and according to at least one embodiment of the present disclosure;

FIGS. 2A-2D illustrate various views of a solar tracking system that includes a first variable angle torque tube connector;

FIGS. 3A-3E illustrate various views of a solar tracking system that includes a second variable angle torque tube connector; and

FIG. 4 illustrates a third variable angle torque tube connector.

### DETAILED DESCRIPTION

Embodiments of the present disclosure will be explained with reference to the accompanying figures. It is to be understood that the figures are diagrammatic and schematic representations of such example embodiments, and are not limiting, nor are they necessarily drawn to scale. In the figures, features with like numbers indicate like structure and function unless described otherwise.

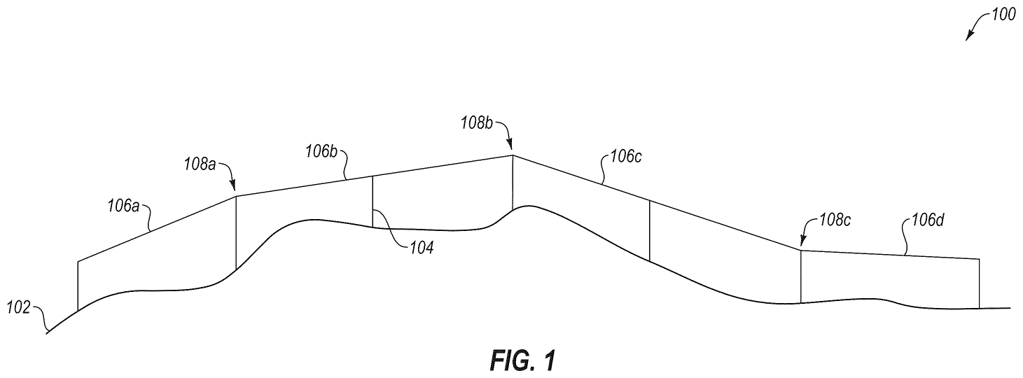

FIG. 1 illustrates a side view of an example solar site 100 that includes elevation changes. The solar site 100 includes a ground surface 102 and a tracking system that includes support structures 104, torque tube sections 106a-106d, variable angle torque tube connectors 108a-108c, and a plurality of PV modules (not shown), which may be mounted to the torque tube sections 106a-106d. The torque tube sections 106a-106d are not collinear. The slope of the torque tube sections 106a-106d roughly follow the slope of the ground surface 102. For example, the torque tube sections 106a and 106b are inclined at slopes that are consistent with the uphill profile of the ground surface 102 below these torque tube sections. The torque tube sections 106c and 106d are declined at slopes that are consistent with the downhill profile of the ground surface 102 below these torque tube sections. Torque tubes, however, are not sufficiently flexible to accommodate changes in inclination. For example, damage or malfunction may occur if some torque tubes are bent beyond an angular threshold amount. In some embodiments, the angular threshold may be between 0.5 degrees and 2 degrees. For example, the angular threshold may be 1 degree. Therefore, the variable angle torque tube connectors 108a-108c are positioned on the support structures 104 at intersections between the torque tube sections 106a-106d. Specifically, the variable angle torque tube connector 108a connects the torque tube sections 106a and 106b, the variable angle torque tube connector 108b connects the torque tube sections 106b and 106c, and the variable angle torque tube connector 108c connects the torque tube sections 106c and 106d.

In addition to connecting the torque tube sections 106a-106d at differing angular orientations, the variable angle torque tube connectors 108a-108c also translate rotation from one torque tube section to another. Specifically, the variable angle torque tube connector 108a translates rotations between the torque tube section 106a and the torque tube section 106b, the variable angle torque tube connector 108b translates rotations between the torque tube section 106b and the torque tube section 106c, and the variable angle torque tube connector 108c translates rotation between the torque tube section 106c and the torque tube section 106d. Further, one or more of the variable angle torque tube connectors 108a-108c may include a drive mechanism that provides a rotational torque to one or more of the torque tube sections 106a-106d. This drive mechanism may provide the torque needed for PV modules attached to the torque tube sections 106a-106d to track the location of the Sun in the sky. This drive mechanism may include one or more gears and a motor.

In one embodiment, the variable angle torque tube connector 108b may include a drive mechanism that rotates torque tube sections 106b and 106c. The torque provided by the drive mechanism may be translated from the torque tube section 106b to the torque tube section 106a through the variable angle torque tube connector 108a. Similarly, the torque provided by the drive mechanism may be translated from the torque tube section 106c to the torque tube section 106d through the variable angle torque tube connector 108c.

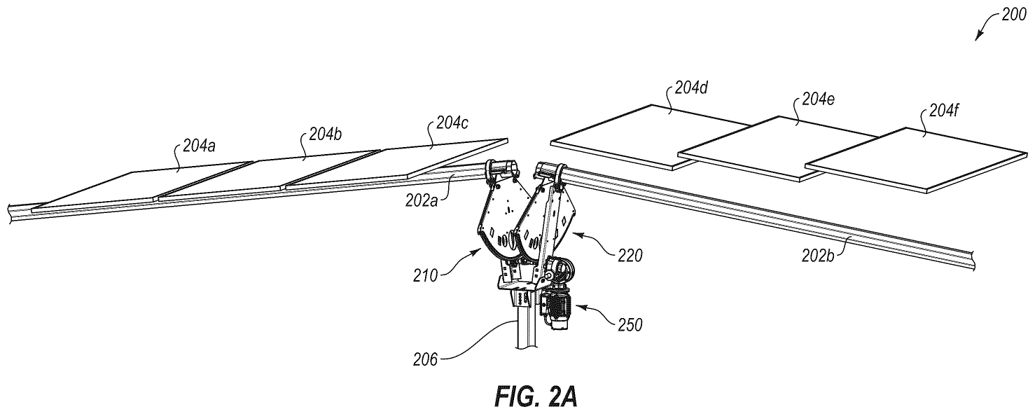

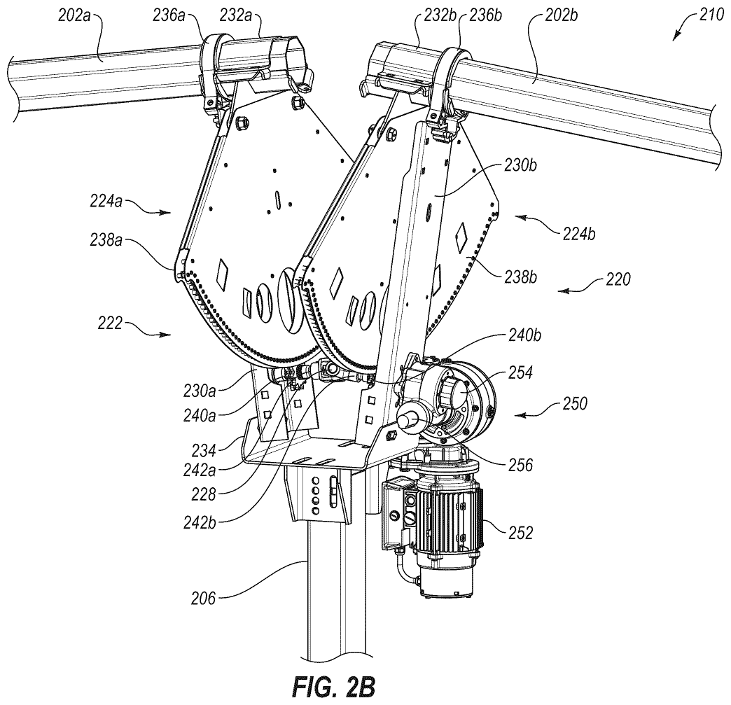

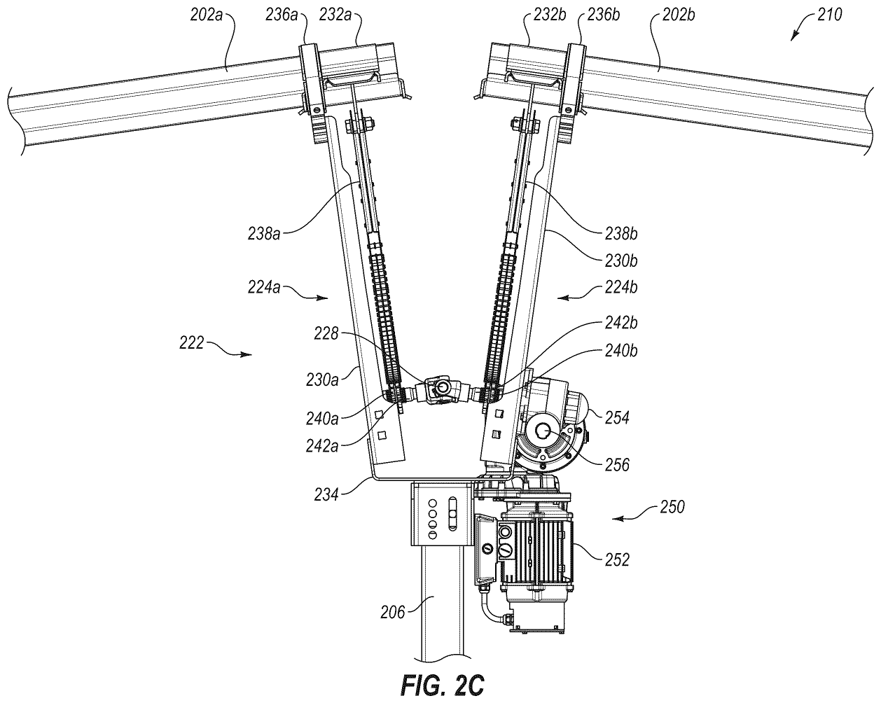

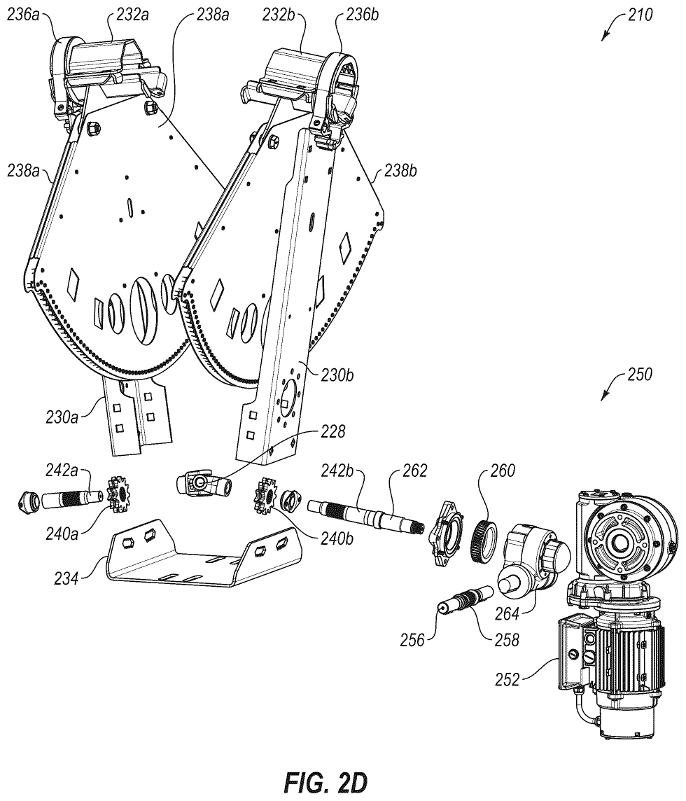

FIG. 2A illustrates a solar tracking system 200 that includes a first torque tube section 202a, a second torque tube section 202b, PV modules 204a-204f, a support structure 206, and a variable angle torque tube connector 210. The PV modules 204a-204c are connected to the torque tube section 202a and the PV modules 204d-204f are connected to the torque tube section 202b. The variable angle torque tube connector 210 secures the torque tube sections 202a and 202b (which are not collinear) to the support structure 206.

The variable angle torque tube connector 210 includes a means for connecting 220 that not only connects the first torque tube section 202a with the second torque tube section 202b at different angles, but also translates rotational movement between the first torque tube section 202a and the second torque tube section 202b. The variable angle torque tube connector 210 also includes a means for applying a rotational torque 250 to the first and second torque tube sections 202a and 202b through a component of the means for connecting 220. The means for connecting 220 and the means for applying a rotational torque 250 are both supported by the support structure 206.

FIGS. 2B-2D illustrate additional views of the variable angle torque tube connector 210. Specifically, FIG. 2B provides a perspective view of the variable angle torque tube connector 210, FIG. 2C provides a side view of the variable angle torque tube connector 210, and FIG. 2D provides an exploded view of the variable angle torque tube connector 210.

The means for connecting 220 includes a frame 222, a first gear 224a, a second gear 224b, and a joint 228. The frame 222 includes a first arm 230a and a second arm 230b, a first sleeve 232a, a second sleeve 232b, and a bottom bracket 234. The first and second arms 230a and 320b are connected to the bottom bracket 234. In some embodiments, bottom portions of the first and second arms 230a and 320b may be connected to the bottom bracket 234 in a way that allows the first and second arms 230a and 320b to pivot toward and away from each other. For example, one or both of the first and second arms 230a and 320b may be secured to the bottom bracket 234 via hinges. In one embodiment, the bottom bracket may include a hinge, such as a piano hinge, at one or both of the bends in the lower bracket that connect the upward flanges to which the first and second arms 230a and 320b are secured. The bottom bracket 234 is also secured to the support structure 206.

Upper ends of the first and second arms 230a and 320b may include sleeve housings 236a and 236b. The sleeve housings 236a and 236b may surround all or a portion of the first and second sleeves 232a and 232b, respectively. The sleeve housings 236a and 236b are rotationally connected to the first and second sleeves 232a and 232b such that the first and second sleeves 232a and 232b are secured within the first and second sleeve housings 236a and 236b in a way that allows the first and second sleeves 232a and 232b to rotate. The first and second sleeves 232a and 232b include openings that are configured to receive and attach to the torque tube sections 202a and 202b, respectively. Unlike the first and second sleeve housings 236a and 236b, the first and second sleeves are fixed to the torque tube sections 202a and 202b, such that the sleeves rotate with the torque tube sections to which they are attached. Thus, the torque tube section 202a is secured within the first sleeve 232a and these components rotate together within the first sleeve housing 236a and relative to the first arm 230a. Similarly, the torque tube section 202b is secured within the second sleeve 232b and these components rotate together within the second sleeve housing 236b and relative to the second arm 230b.

The first and second arms 230a and 320b may be positioned such that the first and second sleeves 232a and 232b are able to accommodate torque tube sections that are not in a straight line but are angled relative to each other. Many different torque tube section angles may be accommodated depending on the position of the first and second arms 230a and 230b. The first torque tube section 202a has an upward slope and the second torque tube section 202b has a downward slope. However, the first and second arms 230a and 320b could be positioned to accommodate a first torque tube section that has a downward slope and a second torque tube section that has an upward slope.

The first gear 224a includes a first toothed wheel 238a, a first pinion 240a, and a first axle 242a. The first gear may be a spur gear, a miter gear, or another type of gear. The first toothed wheel 238a is fixed to the first sleeve 232a such that the first toothed wheel 238a rotates with both the first sleeve 232a and the first torque tube section 202a. The first toothed wheel 238a interfaces with the first pinion 240a to rotate the first pinion 240a as the first toothed wheel 238a rotates. The first axle 242a is rotatably connected to the first arm 230a and is fixed within the first pinion 240a so that rotation of the first pinion 240a also rotates the first axle 242a. Thus, the first gear 224a translates rotation of the first torque tube section 202a to the first axle 242a.

The second gear 224b includes a second toothed wheel 238b, a second pinion 240b, and a second axle 242b. The second gear may be a spur gear, a miter gear, or another type of gear. The second toothed wheel 238b is fixed to the second sleeve 232b such that the second toothed wheel 238b rotates with both the second sleeve 232b and the second torque tube section 202b. The second toothed wheel 238b interfaces with the second pinion 240b to rotate the second pinion 240b as the second toothed wheel 238b rotates. The second axle 242b is rotatably connected to the second arm 230b and is fixed within the second pinion 240b so that rotation of the second pinion 240b also rotates the second axle 242b. Thus, the second gear 224b translates rotation of the second torque tube section 202b to the second axle 242b.

As the positions of the first and second arms 230a and 230b of the frame 222 change to accommodate torque tube sections having different angular orientations, the angular orientations of the first and second axles may also change. Thus, changes in the frame 222 to accommodate first and second torque tube sections having differing angular orientations may cause corresponding changes in the relative angles of the first and second axles 242a and 242b. In some embodiments, the first axle 242a may be parallel to the first torque tube section 202a and the second axle 242b may be parallel to the second torque tube section 202b such that the angle between torque tube sections 202a and 202b is the same as the angle between first and second axles 242a and 242b. In other embodiments, the torque tube sections may not be parallel to corresponding axles.

The joint 228 connects and translates rotation between the first axle 242a and the second axle 242b. Due to the fact that the first and second axles 242a and 242b may not be in line as provided above, the joint 228 may be configured to connect and translate rotation between axles having different angular orientations. For example, the joint 228 may be a universal joint, a constant velocity joint, a cardan joint, a flexible joint, or another joint that connects and translates rotation between axles having different angular orientations.

The means for applying a rotational torque 250 includes a drive mechanism comprising a motor 252, a gear 254, and a drive axle 256. The motor may be an electric motor that rotates the drive axle 256 and may be attached to the support structure 206. The drive axle 256 may rotate a gear that is configured to rotate the first and second torque tubes 202a and 202b. While a variety of different gears may be used, the gear used in the variable angle torque tube connector 210 (which is shown in more detail in FIG. 2D) is a worm gear that includes a worm 258 that is secured to the exterior of the drive axle 256 and a worm wheel 260. The worm wheel 260 is connected to and configured to rotate an output axle 262. In some embodiments, the output axle may be configured to rotate one of the axles that are part of the gears 224a or 224b. For example, the output axle 262 may be an extension of the second axle 242b of the second gear 224b. Through this drive mechanism, the variable angle torque tube connector 210 not only connects torque tube sections and translates rotation between torque tube sections, it also provides a drive torque for rotating the torque tube sections. A cover 264 may enclose the components of the drive mechanism.

The variable angle torque tube connector 210 may be installed at any location in a solar site that includes greater elevation changes than the first torque tube section 202a and/or the second torque tube section 202b may tolerate without damage. For example, the variable angle torque tube connector 210 may be any of the variable angle torque tube connectors 108a-108c illustrated in the solar site 100 of FIG. 1.

Modifications, additions, or omissions may be made to the variable angle torque tube connector 210 without departing from the scope of the present disclosure. For example, in some embodiments, the variable angle torque tube connector 210 may include additional components similar to the components illustrated in FIGS. 2A-2D that each may be configured similarly to the components illustrated in FIGS. 2A-2D. For example, in some embodiments, a variable angle torque tube connector may only include the means for connecting 220 the first and second torque tube sections 202a and 202b and lack a means for applying a rotational torque 250. In another example, the variable angle torque tube connector 210 may include a torque limiter interposed between components in the variable angle torque tube connector 210. This torque limiter may be a friction ring as described in U.S. patent application Ser. No. 18/322,869 (the '869 Application), which is incorporated in its entirety herein.

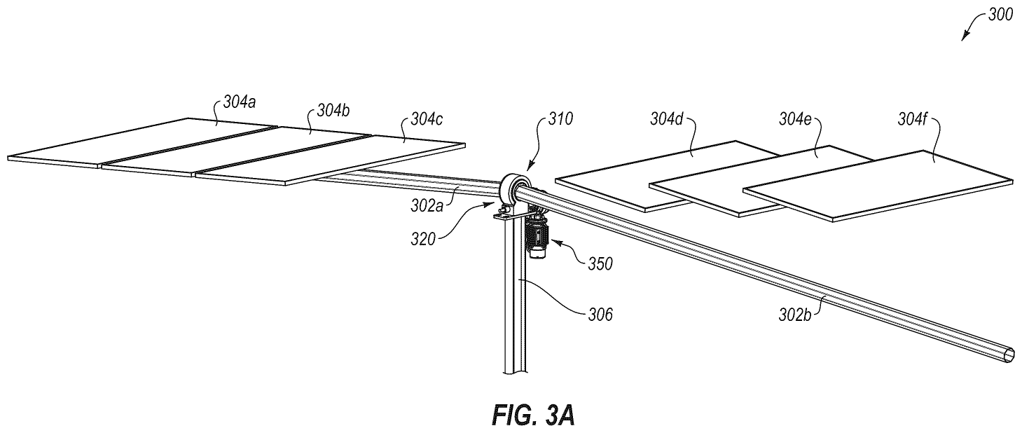

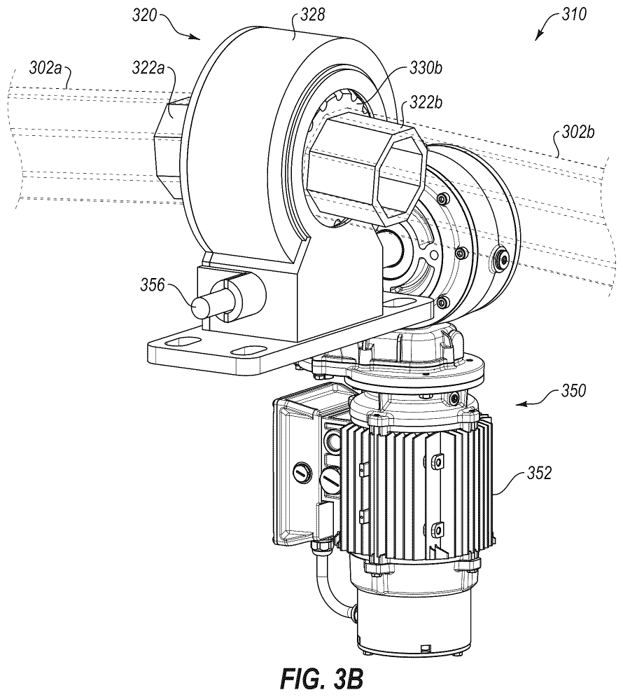

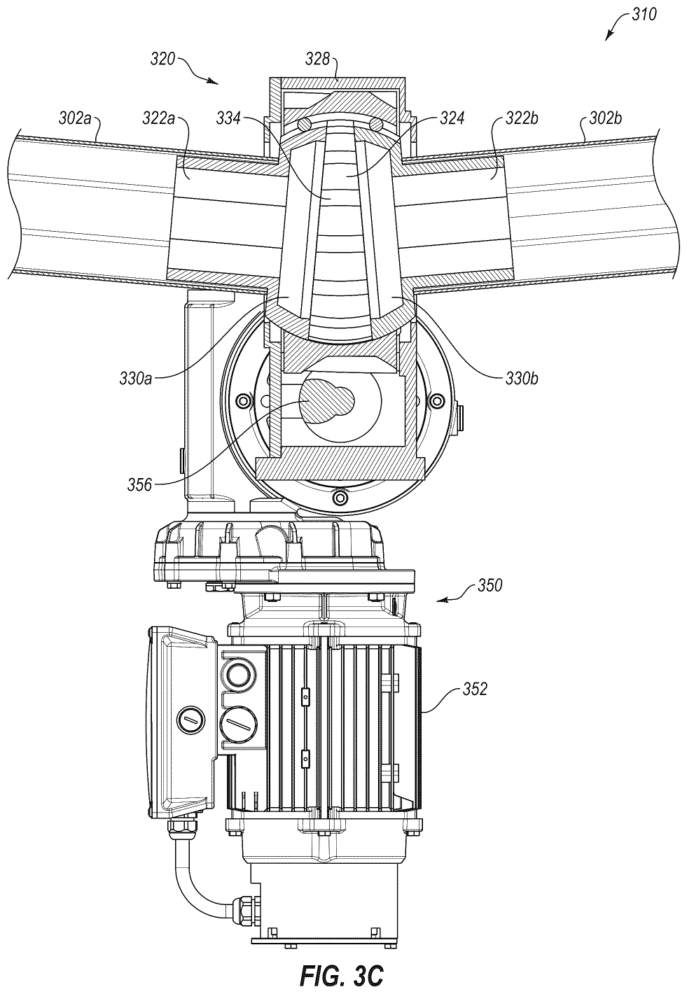

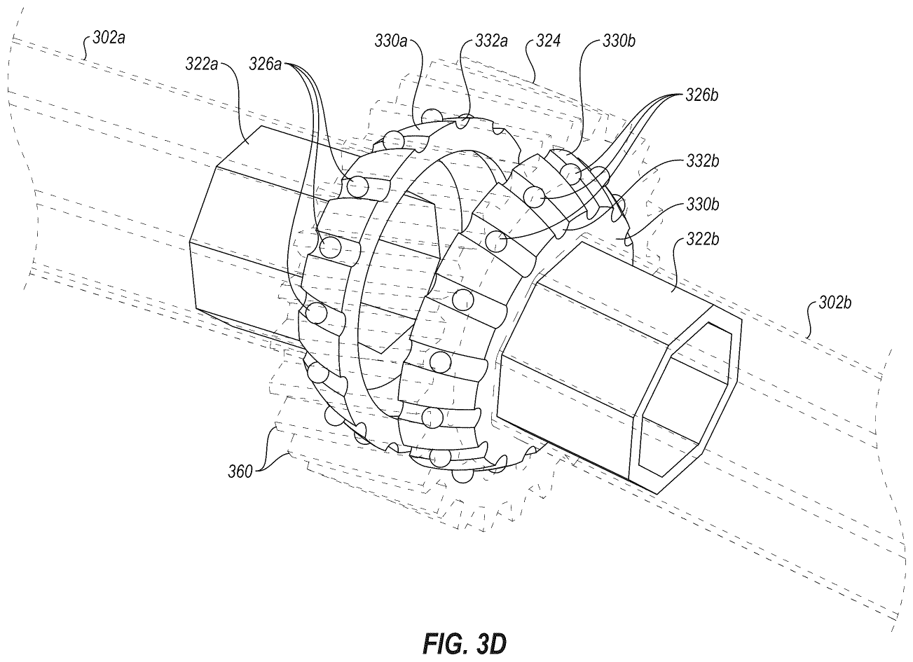

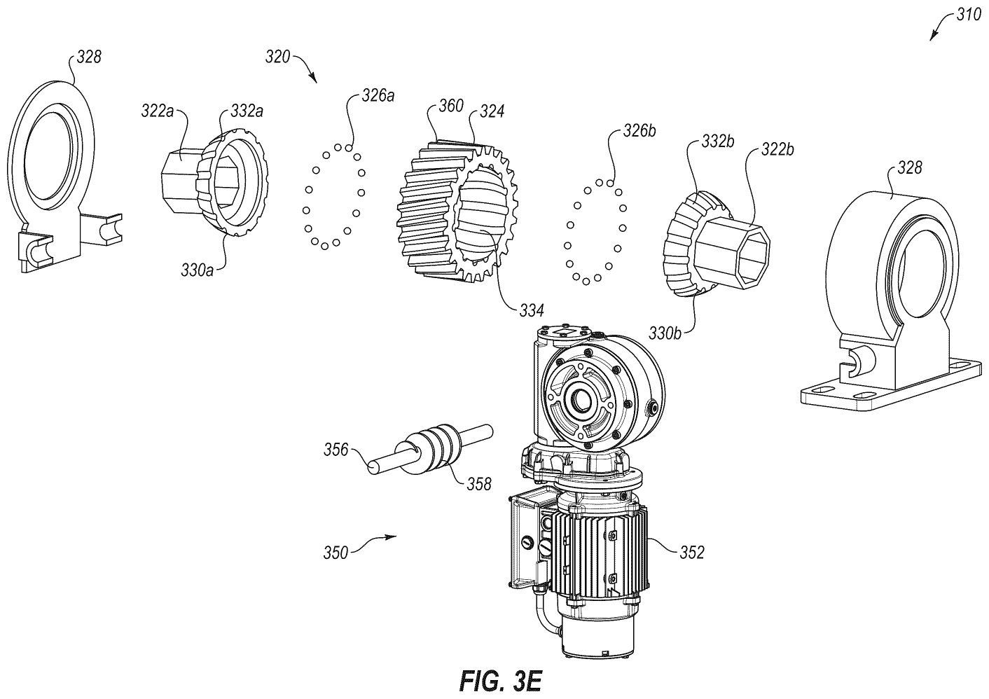

FIG. 3A illustrates a solar tracking system 300 that includes a first torque tube section 302a, a second torque tube section 302b, PV modules 304a-304f, a support structure 306, and a variable angle torque tube connector 310. The PV modules 304a-304c are connected to the torque tube section 302a and the PV modules 304d-304f are connected to the torque tube section 302b. The variable angle torque tube connector 310 secures the torque tube sections 302a and 302b (which are not collinear) to the support structure 306.

The variable angle torque tube connector 310 includes a means for connecting 320 that not only connects the first torque tube section 302a with the second torque tube section 302b at different angles, but also translates rotational movement between the first torque tube section 302a and the second torque tube section 302b. The variable angle torque tube connector 310 also includes a means for applying a rotational torque 350 to the first and second torque tube sections 302a and 302b through a component of the means for connecting 320. The means for connecting 320 and the means for applying a rotational torque 350 are both supported by the support structure 306.

FIGS. 3B-3E illustrate additional views of the variable angle torque tube connector 310. Specifically, FIG. 3B provides a perspective view of the variable angle torque tube connector 310, FIG. 3C provides a cross-sectional side view of the variable angle torque tube connector 310, FIG. 3D provides a view of components of the variable angle torque tube connector 310, and FIG. 3E provides an exploded view of certain components of the variable angle torque tube connector 310.

The means for connecting 320 includes a first torque tube coupler 322a, a second torque tube coupler 322b, an outer ring 324, a first plurality of rollers 326a, a second plurality of rollers 326b, and a housing 328. The first torque tube coupler 322a may be connected to the first torque tube section 302a and the second torque tube coupler 322b may be connected to the second torque tube section 302b. The first torque tube coupler 322a is also secured to a first inner ring 330a and the second torque tube coupler 322b is also secured to a second inner ring 330b. An outer surface of the first inner ring 330a includes a series of exterior grooves 332a and an outer surface of the second inner ring 330b includes a series of exterior grooves 332b. The outer ring 324 surrounds the first and second inner rings 330a and 330b and includes a series of interior grooves 334. The first plurality of rollers 326a may be positioned between the first inner ring 330a and the outer ring 324, within the series of exterior grooves 332a and the series of interior grooves 334. Similarly, the second plurality of rollers 326b may be positioned between the second inner ring 330b and the outer ring 324, within the series of exterior grooves 332b and the series of interior grooves 334. The plurality of rollers 326a and 326b have a spherical shape, however in other embodiments the rollers may have a cylindrical shape, or another shape.

These components may operate together to connect the torque tube section 302a to the torque tube section 302b at variable angles and to translate torque or rotational energy between the torque tube section 302a and the torque tube section 302b. The housing 328 may include openings that are sufficiently large for the first and second torque tube couplers 322a and 322b (and attached torque tube sections 302a and 302b) to rotate to different angular configurations, but sufficiently small that the first and second inner rings 330a and 330b cannot separate from within the outer ring 324.

The means for applying a rotational torque 350 includes a drive mechanism comprising a motor 352, a gear 354, and a drive axle 356. The motor may be an electric motor that rotates the drive axle 356 and may be attached to the support structure 306. The drive axle 356 may rotate a gear that is configured to rotate the first and second torque tubes 302a and 302b. While a variety of different gears may be used, the gear used in the variable angle torque tube connector 310 (which is shown in more detail in FIG. 3E) is a worm gear that includes a worm 358 that is secured to the exterior of the drive axle 356 and a plurality of teeth 360 on an outer surface of the outer ring 324. The outer ring 324 is configured to rotate with the drive axle 356, through the worm 358. Through this drive mechanism, the variable angle torque tube connector 310 not only connects torque tube sections and translates rotation between torque tube sections, it also provides a drive torque for rotating the torque tube sections. The housing 328 may also enclose the components of the drive mechanism.

The variable angle torque tube connector 310 may be installed at any location in a solar site that includes greater elevation changes than the first torque tube section 302a and/or the second torque tube section 302b may tolerate without damage. For example, the variable angle torque tube connector 310 may be any of the variable angle torque tube connectors 108a-108c illustrated in the solar site 100 of FIG. 1.

Modifications, additions, or omissions may be made to the variable angle torque tube connector 310 without departing from the scope of the present disclosure. For example, in some embodiments, the variable angle torque tube connector 310 may include additional components similar to the components illustrated in FIGS. 3A-3E that each may be configured similarly to the components illustrated in FIGS. 3A-3E. For example, in some embodiments, a variable angle torque tube connector may only include the means for connecting 320 the first and second torque tube sections 302a and 302b and lack a means for applying a rotational torque 350. In another example, the variable angle torque tube connector 310 may include a torque limiter interposed between components in the variable angle torque tube connector 310. This torque limiter may be a friction ring as described in the '869 Application.

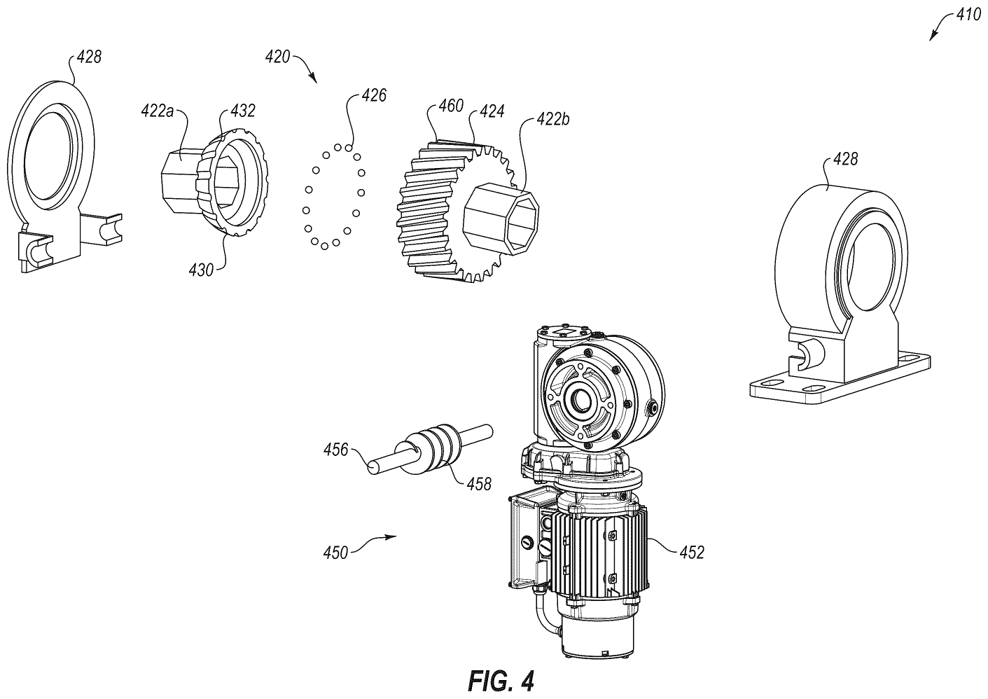

FIG. 4 illustrates an exploded view of a variable angle torque tube connector 410, which may be attached to a support structure (not shown). The variable angle torque tube connector 410 includes a means for connecting 420 that can not only connect a first torque tube section with a second torque tube section at different angles but can also translate rotational movement between these torque tube sections. The variable angle torque tube connector 410 also includes a means for applying a rotational torque 450 to first and second torque tube sections through a component of the means for connecting 420.

The means for connecting 420 includes a first torque tube coupler 422a, a second torque tube coupler 422b, an outer ring 424, a plurality of rollers 426, and a housing 428. The first torque tube coupler 422a may be connected to a first torque tube section (not shown) and the second torque tube coupler 422b may be connected to a second torque tube section (not shown). The first torque tube coupler 422a is also secured to an inner ring 430. An outer surface of the inner ring 430 includes a series of exterior grooves 432. The second torque tube coupler 422b is secured to the outer ring 424, which surrounds the inner ring 430 and includes a series of interior grooves (not shown). The plurality of rollers 426 may be positioned between the inner ring 430 and the outer ring 424, within the series of exterior grooves 432 on the inner ring 430 and the series of interior grooves on the outer ring 424. The plurality of rollers 426 have a spherical shape, however in other embodiments the rollers may have a cylindrical shape, or another shape.

These components may operate together to connect two torque tube sections at variable angles and to translate torque or rotational energy between them. The housing 428 may include an opening that is sufficiently large for the first torque tube coupler 422a (and an attached torque tube sections) to rotate to different angular configurations relative to the second torque tube coupler 422b, but sufficiently small that the inner ring 430 cannot separate from within the outer ring 424.

The means for applying a rotational torque 450 includes a drive mechanism comprising a motor 452, a gear 454, and a drive axle 456. The motor may be an electric motor that rotates the drive axle 456 and is attached to a support structure. The drive axle 456 may rotate a gear that is configured to rotate torque tubes that are connected by the variable angle torque tube connector 410. While a variety of different gears may be used, the gear used in the variable angle torque tube connector 410 is a worm gear that includes a worm 458 that is secured to the exterior of the drive axle 456 and a plurality of teeth 460 on an outer surface of the outer ring 424. The outer ring 424 is configured to rotate with the drive axle 456, through the worm 458. Through this drive mechanism, the variable angle torque tube connector 410 not only connects torque tube sections and translates rotation between torque tube sections, it also provides a drive torque for rotating the torque tube sections. The housing 428 may also enclose the components of the drive mechanism.

The variable angle torque tube connector 410 may be installed at any location in a solar site that includes greater elevation changes than torque tube sections to be connected may tolerate without damage. For example, the variable angle torque tube connector 410 may be any of the variable angle torque tube connectors 108a-108c illustrated in the solar site 100 of FIG. 1.

Modifications, additions, or omissions may be made to the variable angle torque tube connector 410 without departing from the scope of the present disclosure. For example, in some embodiments, the variable angle torque tube connector 410 may include additional components similar to the components illustrated in FIG. 4 that each may be configured similarly to the components illustrated in FIG. 4. For example, in some embodiments, a variable angle torque tube connector may only include the means for connecting 420 and lack a means for applying a rotational torque 450. In another example, the variable angle torque tube connector 410 may include a torque limiter interposed between components in the variable angle torque tube connector 410. This torque limiter may be a friction ring as described in the '869 Application.

In accordance with common practice, the various features illustrated in the drawings may not be drawn to scale. The illustrations presented in the present disclosure are not meant to be actual views of any particular apparatus (e.g., device, system, etc.) or method, but are merely example representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., device) or all operations of a particular method.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the summary, detailed description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absent a showing that the terms “first,” “second,” “third,” etc., connote a specific order, these terms should not be understood to connote a specific order. Furthermore, absent a showing that the terms “first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

The foregoing description, for purpose of explanation, has been described with reference to specific embodiments. However, the illustrative discussions above are not intended to be exhaustive or to limit the invention as claimed to the precise forms disclosed. Many modifications and variations are possible in view of the above teachings. The embodiments were chosen and described to explain practical applications, to thereby enable others skilled in the art to utilize the invention as claimed and various embodiments with various modifications as may be suited to the particular use contemplated.

What is claimed is:

1. A system for connecting and rotating torque tube sections at variable angles in a solar tracking system comprising:
a first torque tube section;
a second torque tube section, wherein the first torque tube section and the second torque tube section are not collinear;
a connector including:
means for connecting the first torque tube section with the second torque tube section such that rotational movement from the first torque tube section is translated to the second torque tube section; and
means for applying a rotational torque to a component of the means for connecting the first torque tube section with the second torque tube section.

2. The system of claim 1, wherein the means for connecting includes:
a frame rotatably connected to the first torque tube section and the second torque tube section;
a first gear fixed to the first torque tube section that translates rotation from the first torque tube section to a first axle;
a second gear fixed to the second torque tube section that translates rotation from the second torque tube section to a second axle; and
a joint that connects and translates rotation from the first axle to the second axle.

3. The system of claim 2, wherein the joint that connects and translates rotation from the first axle to the second axle is a universal joint or a constant velocity joint.

4. The system of claim 2, wherein:
the first gear includes a first toothed wheel, a first pinion, and a first axle, and
the second gear includes a second toothed wheel, a second pinion, and a second axle.

5. The system of claim 4, wherein the frame includes:
a first sleeve that is fixed to the first torque tube section and is rotatably connected to a first arm of the frame; and
a second sleeve that is fixed to the second torque tube section and is rotatably connected to a second arm of the frame;
wherein the first toothed wheel is fixed to the first sleeve and the second toothed wheel is fixed to the second sleeve.

6. The system of claim 5, wherein the means for applying a rotational torque includes a gear and a motor.

7. The system of claim 6, wherein the gear is a worm gear that includes a drive axle, a worm, a worm wheel, and an output axle, and the motor provides a rotational torque to the first and second axles through the output axle.

8. The system of claim 1, wherein the means for connecting includes:
a first torque tube coupler fixed to an inner ring and coupled to the first torque tube section, the inner ring including exterior grooves;
a second torque tube coupler fixed to an outer ring that surrounds the inner ring and coupled to the second torque tube section, the outer ring including interior grooves; and
a plurality of rollers positioned between the exterior grooves of the inner ring and the interior grooves of the outer ring.

9. The system of claim 8, wherein the means for applying a rotational torque includes a gear and a motor.

10. The system of claim 9, wherein the gear is a worm gear that includes a drive axle, a worm, and a plurality of teeth on an outer surface of the outer ring, and the motor provides a rotational torque to the first and second torque tube couplers through the outer ring.

11. The system of claim 1, wherein the means for connecting includes:
a first torque tube coupler fixed to a first inner ring and coupled to the first torque tube section, the first inner ring including exterior grooves;
a second torque tube coupler fixed to a second inner ring and coupled to the second torque tube section, the second inner ring including exterior grooves;
an outer ring that surrounds the first inner ring and the second inner ring, the outer ring including interior grooves; and
a plurality of rollers positioned between the exterior grooves of the first and second inner rings and the interior grooves of the outer ring.

12. The system of claim 11, wherein the means for applying a rotational torque includes a gear and a motor.

13. The system of claim 12, wherein the gear is a worm gear that includes a drive axle, a worm, and a plurality of teeth on an outer surface of the outer ring, and the motor provides a rotational torque to the first and second torque tube couplers through the outer ring.

14. A connector for coupling torque tube sections at variable angles in a solar tracking system comprising:
a frame including a first sleeve that is rotatably connected to a first arm of the frame, and a second sleeve that is rotatably connected to a second arm of the frame, wherein the first sleeve is configured to be fixed to a first torque tube section and the second sleeve is configured to be fixed to a second torque tube section;
a first gear including a first toothed wheel, a first pinion, and a first axle, wherein the first toothed wheel is fixed to the first sleeve to translate rotation from the first torque tube section to the first axle;
a second gear including a second toothed wheel, a second pinion, and a second axle, wherein the second toothed wheel is fixed to the second sleeve to translate rotation from the second torque tube section to the second axle; and
a joint that connects and translates rotation from the first axle to the second axle.

15. The connector of claim 14, wherein the joint that connects and translates rotation from the first axle to the second axle is a universal joint or a constant velocity joint.

16. The connector of claim 14, further comprising:
a worm gear; and
a motor,
wherein the worm gear includes a drive axle, a worm, a worm wheel, and an output axle, and the motor provides a rotational torque to the first and second axles through the output axle.

17. A connector for coupling torque tube sections at variable angles in a solar tracking system comprising:
a first torque tube coupler configured to be coupled to a first torque tube section, the first torque tube coupler being fixed to an inner ring that includes exterior grooves;
a second torque tube coupler configured to be coupled to a second torque tube section, the second torque tube coupler being fixed to an outer ring that surrounds the inner ring, the outer ring including interior grooves; and
a plurality of rollers positioned between the exterior grooves of the inner ring and the interior grooves of the outer ring.

18. The connector of claim 17, further comprising:
a worm gear; and
a motor,
wherein the worm gear includes a drive axle, a worm, and a plurality of teeth on an outer surface of the outer ring, and the motor provides a rotational torque to the first and second torque tube couplers through the outer ring.

19. A connector for coupling torque tube sections at variable angles in a solar tracking system comprising:
a first torque tube coupler configured to be coupled to a first torque tube section, the first torque tube coupler being fixed to a first inner ring that includes exterior grooves;
a second torque tube coupler configured to be coupled to a second torque tube section, the second torque tube coupler being fixed to a second inner ring that includes exterior grooves;
an outer ring that surrounds the first inner ring and the second inner ring, the outer ring including interior grooves; and
a plurality of rollers positioned between the exterior grooves of the first and second inner rings and the interior grooves of the outer ring.

20. The connector of claim 19, further comprising:
a worm gear; and
a motor,
wherein the worm gear includes a drive axle, a worm, and a plurality of teeth on an outer surface of the outer ring, and the motor provides a rotational torque to the first and second torque tube couplers through the outer ring.
